(19) United States
(12) Patent Application Publication
(10) Pub. No.: US 2023/0249569 A1
(43) Pub. Date: Aug. 10, 2023

(54) CHARGING STATION FOR AN ELECTRIC MOTOR VEHICLE

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 17/768,862

(22) PCT Filed: Oct. 15, 2020
(86) PCT No.: PCT/EP2020/079060

§ 371 Date: Apr. 14, 2022

(30) Foreign Application Priority Data
Oct. 16, 2019 (DE) 10 2019 127 990.9

(51) Int. Cl. B60L 53/57; H02J 7/00; B60L 53/31; F02M 31/125

(52) U.S. Cl. CPC B60L 53/57; B60L 53/31; F02M 31/125; H02J 7/0042

(57) ABSTRACT

The invention relates to a charging column that is suitable for charging electric vehicles, with an internal combustion engine, a tank for a liquid energy carrier, a fuel line from the tank to the internal combustion engine, a fuel heating device for heating the fuel in the fuel line, a generator, a connection device that is adapted to be connected to an electric vehicle, wherein the device for connecting the electric vehicle is suitable for transmitting electric energy to the electric vehicle and wherein the generator is coupled to the internal combustion engine in such a way that the kinetic energy generated by the internal combustion engine can be converted into electric energy by the generator.

The invention relates to a charging column that is suitable for charging electric vehicles, with an internal combustion engine, a tank for a liquid energy carrier, a fuel line from the tank to the internal combustion engine, a fuel heating device for heating the fuel in the fuel line, a generator, a connection device that is adapted to be connected to an electric vehicle, wherein the device for connecting the electric vehicle is suitable for transmitting electric energy to the electric vehicle and wherein the generator is coupled to the internal combustion engine in such a way that the kinetic energy generated by the internal combustion engine can be converted into electric energy by the generator.

### PRIOR ART

With the spread of electric vehicles that are operated with an electric motor, a functioning infrastructure for charging the electric vehicles must be made available. In addition to charging at home, users of electric vehicles must also be given the opportunity to purchase energy in the public sector. Given the ranges of electric vehicles that have been available so far, it is necessary for the vehicles to be able to be charged outside of the home. Therefore, charging stations must be provided in public areas to ensure constant availability of energy for electric vehicles through a supply network.

Stationary systems are known for supplying electricity to stationary charging columns in order to recharge the traction battery of a plug-in vehicle-hybrid or electric vehicle-as described, for example, in DE 10 2009 016 505 A1. The charging column itself is connected to the power supply on a power rail. An existing power grid has a connection element for outputting electric energy to an electric vehicle.

Such a charging column has the disadvantage that it cannot be flexibly erected or dismantled. The costs for the construction and particularly the connection of the charging column to the existing power grid are also very high. So, if the charging column is only to remain temporarily at the current location, setting it up and dismantling it causes unnecessarily high costs. Charging columns that are designed to be transportable can be used more flexibly.

Patent “DE 10 2010 043 516 A1 - Device for rapid charging of an electric energy storage device of a vehicle” held by Power Innovation Stromversorgungstechnik GmbH discloses a device for exchanging electric energy. The device has an electric energy store (battery pack) that charges the energy store of the vehicle via a programmable controller and an AC/DC converter. The energy store of the device itself is recharged via various DC voltage sources. All components (energy store, controller, converter) are arranged in one device, while the DC voltage source for charging the energy store is external and remote from the device.

This charging column has the disadvantage that it is designed so large and heavy that it can only be set up and operated on a large area, for example in parking lots of shopping centers. Their use in parking garages, for example, is not possible. A connection to an existing power grid is also necessary.

The utility model specification “DE 20 2010 011 567 U1 - Mobile charging station” held by Beton- und Energietechnik Heinrich Gräper GmbH & Co. KG discloses a transportable charging station that is arranged within a transportable station building. The building has multiple rooms and is made of concrete. Fuel cell modules, storage tanks for the fuel (hydrogen, methane, biogas) and an inverter are arranged in the building. The building also has a photovoltaic system for self-sufficiency.

This charging column is also very large and heavy. At least one truck is required to transport it.

Patent “DE 10 2017 207 023B4 - charging system and method for operating a charging system” held by AUDI AG discloses a charging system that has a transportable charging station. The charging station has a generator that is operated using a synthetic fuel. Excess energy is stored in an intermediate storage device (battery pack) which is arranged in the charging station. The fuel itself is manufactured in an external fuel manufacturing facility. The fuel is synthesized from the carbon dioxide in the atmosphere using regenerative energy sources.

This charging column requires synthetic fuel to operate, which is currently not available or only available in small quantities and is therefore very expensive. Operating the charging column is therefore also very expensive, and a supply of the required synthetic fuel is not guaranteed.

Document “EP 1 513 211 A2 - Fuel supply device for direct methanol fuel cells” held by Samsung Electronics Co., Ltd. describes a methanol-powered fuel cell having a detachable and attachable tank for the methanol. The cavity in the fuel cell is filled by the tank. This charging device delivers such low power that it cannot be used for motor vehicles. The fuel cell is substantially designed for recharging handheld electronic devices (PDA, notebooks, smartphones...).

It is therefore the object of the present invention to provide a self-sufficiently functioning charging column for motor vehicles which is suitable for recharging electric vehicles in a short time and which works in the most environmentally friendly manner possible.

The stated object is achieved by means of the charging column according to claim 1. Further advantageous embodiments of the invention are set out in the dependent claims.

The charging column according to the invention, which is suitable for charging electric vehicles, has an internal combustion engine, a tank for a liquid energy carrier, and a fuel line between the tank and the internal combustion engine. In addition, the charging column has a fuel heating device that is suitable for heating the liquid energy carrier in the fuel line. Furthermore, the charging column has a generator which is coupled to the internal combustion engine in such a way that the kinetic energy generated by the internal combustion engine can be converted into electric energy. In addition, the charging column has a connection device that is adapted to be connected to an electric vehicle and to transmit electric energy to the electric vehicle.

The use of fuels with a low vapor pressure and particularly a high evaporation heat to operate a spark-ignition engine has problems, particularly during a cold start and in the cold operating phase-when the internal combustion engine has not yet reached the optimum operating temperature. It has been found that it is difficult or even impossible to start internal combustion engines with such fuels at ambient temperatures below 20° C. due to the low vapor pressure and the high evaporation heat. During the cold-run phase, the internal combustion engine runs rough and/or has high emissions of carbon monoxide (CO) and uncombusted hydrocarbon. The exhaust gases, particularly during the starting process and during the cold-running phase, require complex after-treatment. These problems do not occur in internal combustion engines that are operated with conventional gasoline or diesel fuel, which have a lower evaporation heat. A suitable measure for remedying these problems is fuel preheating, which can be implemented very easily and therefore also inexpensively by means of a fuel heating device. When using a fuel heating device, the air-fuel mixture has such a high temperature that the fuel particles are finely distributed and are burned almost stoichiometrically in the internal combustion engine. The exhaust behavior of the internal combustion engine, especially during the starting process and during the cold-running phase, is thus significantly improved.

In one embodiment of the invention, the charging column is a stationary charging column that is provided and designed for stationary operation. In the context of this invention, stationary operation is understood to mean the operation for carrying out a plurality of charging processes at one position. However, this does not restrict the easy portability of the charging column, which can be set up independently of supply or disposal connections and works self-sufficiently. It is therefore also possible to move the charging column around with little effort if the previous installation site proves to be unsuitable, is to be used for something else, or a better site for the charging column has been found. Furthermore, for the purpose of maintenance or repair, the charging column can easily be loaded onto a transport vehicle in order to carry out this work in a workshop.

In another embodiment of the invention, the charging column has an electric energy store which is suitable and intended for providing the electric energy required for starting and/or operating the fuel heating device. The energy store supplies the fuel heating device with energy. The electric energy store is advantageously configured to be rechargeable.

In another embodiment of the invention, the internal combustion engine is suitable and intended to be operated with a liquid energy carrier having a methanol and/or ethanol content of at least 50% by volume. The tank contains the liquid fuel having a methanol and/or ethanol content of at least 50% by volume. Both types of fuel can be produced from biomass in an environmentally friendly and sustainable manner, have long been established as fuels worldwide and are therefore available at low cost. Their transport and storage as well as their operation are comparable to conventional gasoline and are therefore unproblematic. Optionally, fuels with an ethanol and/or methanol content of at least 75% by volume, preferably 85% by volume, and particularly preferably 95% by volume, can also be used.

In another embodiment of the invention, the charging column has a control unit that is suitable and intended for controlling the operation of the fuel heating device. The fuel heating device is started when the charging process begins, and the fuel heating device is switched off when the charging process is completed. Depending on the design of the fuel heating device, its energy output is also regulated so that the temperature of the fuel heated by the fuel heating device is within a range selected by the operator of the charging column. The beginning of the charging process is, for example, the first information sent to the charging column that a charging process should be started. This can be, for example, the authentication of the user, the connection of a charging cable or waking up of the charging column from stand-by mode. In any case, however, the start of the charging process is before the internal combustion engine starts to generate the electric energy.

In another aspect of the invention, the fuel heating device has a PTC ceramic or an electrical resistance heater. Both designs work reliably, are easy to control via the current they conduct and can be implemented cost-effectively. A PTC auxiliary heater has the additional advantage that it is self-regulating, i.e., a preset maximum temperature cannot be exceeded due to the design.

In another embodiment of the invention, the fuel heating device is arranged in such close proximity to the fuel line that the fuel in the fuel line can be heated effectively and without great heat loss.

In another embodiment of the invention, the waste heat from the fuel heating device can be used to heat the fuel line. The fuel heating device itself is usually heated, and the heat from the fuel heating device is used to heat the fuel in the fuel line.

In another embodiment of the invention, the engine block of the internal combustion engine is heated with the fuel heating device to obtain an ignitable fuel mixture.

In a further development of the invention, the charging column has a housing in which the internal combustion engine, the fuel line, the fuel heating device, the control unit, the generator and/or the electric energy store are arranged. The dimensions of the charging column are very compact and it can be transported, set up, operated and dismantled as a complete component. Particularly in rural areas, the charging column according to the invention offers advantages over conventional charging columns that have to be connected to an existing power grid: the costs of the charging column and thus the investments for installation and operation are low. If the charging column cannot be operated profitably at the selected location, it can easily be dismantled. Even in the case of structural measures in the immediate vicinity of the charging column, it can be quickly removed and reassembled at another, more suitable location.

In another embodiment of the invention, the charging column exclusively has lines and/or connections that are suitable for conducting electric energy out of the charging column. The electric energy generated in the charging column is delivered to a motor vehicle via one or more electrical connections (charging cables). The charging column has no other electrical connections outside the housing. The charging column therefore does not require a connection to an existing power grid. The costs of the charging column and thus the investments for installation and operation are low.

In another embodiment of the invention, the fuel heating device of the charging column is designed as a heating device for heating the intake air. When the fuel-air mixture is formed with the preheated air, the fuel is then heated as well. In this embodiment, the fuel heating device can be designed, for example, as a heat exchanger, PCT heater and/or resistance heater. Furthermore, the intake air can also be heated by waste heat from other components of the charging column, such as the motor, or electrical components, such as the rectifier. For this, however, it is necessary for the air duct to be routed over a certain distance along a respectively heat-emitting component of the charging column.

The stated object is also achieved by means of the method according to the invention for generating a charging current for charging electric vehicles according to claim 9.

The method according to the invention for generating electric energy in a charging column for charging electric vehicles has five method steps: In the first method step, a liquid energy carrier is fed from a tank to an internal combustion engine. A fuel pump is usually used for this purpose, which is operated by means of the energy storage device installed in the charging column. The charging process begins when, for example, a user plugs the electrical connection (charging cable) into the corresponding socket of the motor vehicle to be charged. In the second process step, the liquid energy carrier is heated. The heating is carried out by a fuel heating device which, for example, heats the fuel line. In the third process step, the internal combustion engine is operated with the heated liquid energy carrier. In the fourth process step, the kinetic energy generated by the combustion engine is converted into electric energy. In the fifth method step, the generated electric energy is delivered to an electric vehicle.

It has been found that it is difficult to start internal combustion engines at ambient temperatures below 10° C. when using fuels with low vapor pressures and high vaporization enthalpies. During the cold-run phase, the internal combustion engine runs rough and/or has high emissions of carbon monoxide (CO) and uncombusted hydrocarbon. The exhaust gases, particularly during the starting process and during the cold-running phase, require complex after-treatment. These problems do not occur in internal combustion engines that are operated with conventional gasoline or diesel fuel, which have a lower evaporation heat. A suitable measure for remedying these problems is fuel preheating, which can be implemented very easily and therefore also inexpensively by means of a fuel heating device. When using a fuel heating device, the air-fuel mixture has such a high temperature that the fuel particles are finely distributed and are burned almost stoichiometrically in the internal combustion engine. The exhaust behavior of the internal combustion engine, especially during the starting process and during the cold-running phase, is thus significantly improved.

In one embodiment of the invention, the method is carried out in a stationary charging column in stationary operation. In the context of this invention, stationary operation is understood to mean the operation for carrying out a plurality of charging processes at one position. However, this does not restrict the easy portability of the charging column, which can be set up independently of supply or disposal connections and works self-sufficiently. It is therefore also possible to move the charging column around with little effort if the previous installation site proves to be unsuitable, is to be used for something else, or a better site for the charging column has been found. Furthermore, for the purpose of maintenance or repair, the charging column can easily be loaded onto a transport vehicle in order to carry out this work in a workshop.

In another embodiment of the invention, the fuel heating device is started and/or operated by electric energy from an energy store. The energy store is advantageously rechargeable and supplies the fuel heating device with energy as soon as the charging process is started by a user.

In another embodiment of the invention, the liquid energy carrier, which is heated in the fuel line, has a methanol and/or ethanol content of at least 50% by volume. Both types of fuel can be produced from biomass in an environmentally friendly and sustainable manner, have long been established as fuels worldwide and are therefore available at low cost. Their transport and storage as well as their operation are comparable to conventional gasoline and are therefore unproblematic. Optionally, fuels with an ethanol and/or methanol content of at least 75% by volume, preferably 85% by volume, and particularly preferably 95% by volume, can also be used.

In a further development of the invention, the fuel heating device is arranged in such close proximity to the fuel line that the fuel in the fuel line can be heated effectively and without great heat loss.

In another aspect of the invention, the fuel heating device is operated by a control unit. The fuel heating device is started when the charging process begins, and the fuel heating device is switched off when the charging process is completed. Depending on the design of the fuel heating device, its energy output is also regulated so that the temperature of the fuel heated by the fuel heating device is within a range selected by the operator of the charging column.

In another embodiment of the invention, the fuel is heated by a PTC ceramic or an electrical resistance heater. Both designs work reliably, are easy to control via the current they conduct and can be implemented cost-effectively. A PTC auxiliary heater has the additional advantage that it is self-regulating, i.e., a preset maximum temperature cannot be exceeded due to the design.

In another embodiment of the invention, the heated fuel is atomized, for example by means of a carburetor or an injection nozzle.

In another embodiment of the invention, the heated fuel is mixed with a gas to form a fuel-gas mixture and then ignited in the combustion chamber of the internal combustion engine. The internal combustion engine is a piston internal combustion engine, which is spark-ignited according to the Otto principle (4-stroke) using a spark plug, for example, and works with intake manifold injection. The heated fuel is atomized by means of a fuel injection valve in the intake tract in front of the intake valve of the combustion engine in order to form an ignitable mixture with the oxygen in the air.

In another embodiment of the invention, the kinetic energy generated by the internal combustion engine is transferred to a generator and converted into electric energy by the latter. The internal combustion engine drives the generator by rotation, so the kinetic energy generated by the internal combustion engine is converted into electric energy by the generator.

In another aspect of the invention, the power output of the electric energy is controlled by changing the load and/or the fuel metering. The power of the charging column is therefore scalable and can be adjusted to different motor vehicles to be charged.

In another embodiment of the invention, the internal combustion engine is operated in a constant speed range from 1500 rpm to 6000 rpm. The combustion engine runs in a defined, constant speed range of +/- 200 rpm. This is usually in the partial load range to ensure efficient fuel consumption. At the same time, this reduces wear.

In a further development of the invention, a transmission is arranged between the internal combustion engine and the generator, which is designed in such a way that the current generated by the generator alternates at a frequency of 50 Hz. This frequency corresponds to the frequency of the alternating current in households. Motor vehicles that do not have devices for changing the charging current and/or have to be charged using household electricity, for example e-bikes or the like, can therefore also be charged using the charging column according to the invention and the method according to the invention for generating electric energy.

In another embodiment of the invention, the kinetic energy is transmitted from the internal combustion engine to the generator by means of a toothed belt or chain. Driving the generator by means of a toothed belt or toothed chain is inexpensive and at the same time not prone to failure. In addition, the speeds of the internal combustion engine and generator can be reduced or increased in a simple manner.

In a particularly advantageous embodiment of the invention, the fuel is heated by the fuel heating device to a temperature T of at least 25° C., preferably at least 30° C., and particularly preferably at least 35° C. Depending on the operating conditions of the internal combustion engine, an operator of the charging column can adjust the temperature of the fuel; a fuel temperature of at least 35° C., particularly during the starting process and in the cold-running phase of the internal combustion engine, is particularly preferred. It has been found that this temperature of the fuel ensures a rapid starting process. The cold-running phase is shortened and the exhaust gases do not have to be extensively post-treated. Depending on the type of fuel, the fuel can also be heated to 10° C., preferably to 15° C., and particularly preferably to 20° C. This is the case, for example, when using methanol.

In another embodiment of the invention, the fuel is heated as a result of mixing with preheated air. In this optional method, the air supplied to the combustion chamber of the internal combustion engine is first heated. As the preheated air mixes with the atomized fuel, the fuel is heated prior to ignition of the fuel-air mixture. In an alternative embodiment, the fuel is already heated by the preheated air before it is atomized in the combustion chamber of the internal combustion engine. The waste heat from components of the charging column, such as the motor itself, or also electrical components of the charging column can be used to heat the intake air. Alternatively, additional heating elements can heat the intake air. This can be heat exchangers, PTC heaters, or other resistance heaters.

Exemplary embodiments of the charging column according to the invention for charging electric vehicles and the method according to the invention for generating a charging current for charging electric vehicles are shown schematically in simplified form in the drawings and are explained in more detail in the following description. Wherein:

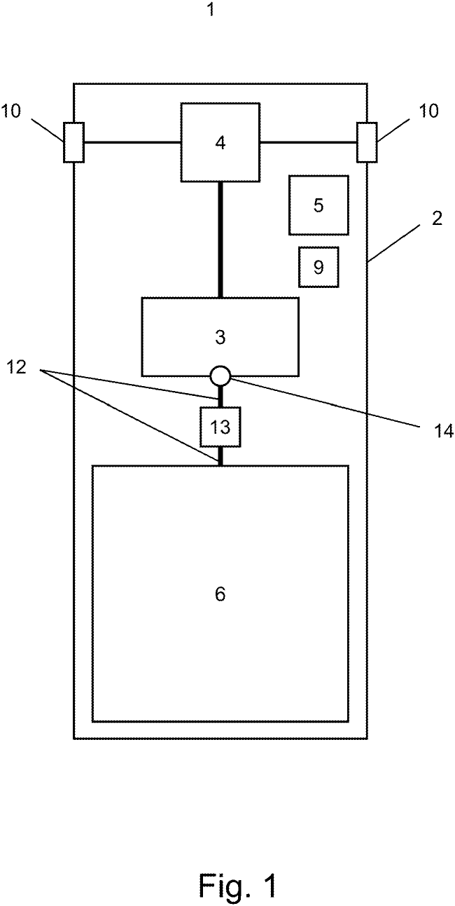

FIG. 1: shows an exemplary embodiment of the charging column according to the invention with a resistance heater

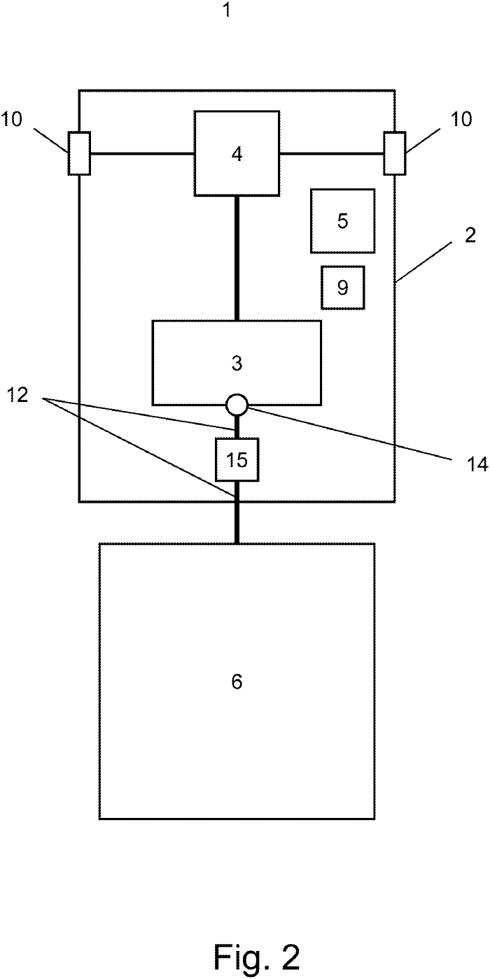

FIG. 2: shows an exemplary embodiment of the charging column according to the invention with a PTC heater

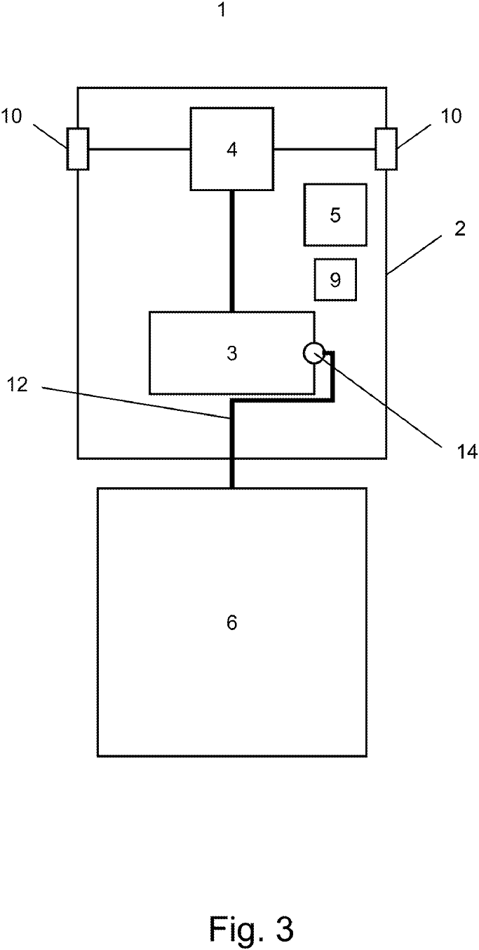

FIG. 3: shows an exemplary embodiment of the charging column according to the invention without a separate fuel heating device,

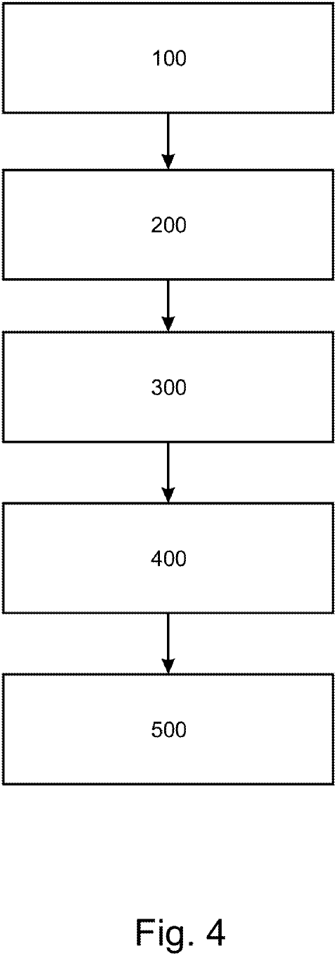

FIG. 4: shows an exemplary embodiment of the method according to the invention for charging electric vehicles

An exemplary embodiment of the charging column 1 according to the invention is shown in FIG. 1. The charging column 1 has an internal combustion engine 3. The internal combustion engine 3 is usually a piston combustion engine 3, which is externally ignited according to the Otto principle (4-stroke) by means of a spark plug, for example. However, other designs are also possible, such as a Wankel engine or turbine. The internal combustion engine 3 has intake manifold injection, in which the fuel is atomized by means of a fuel injection valve 14 in the intake tract upstream of the intake valve of the internal combustion engine 3 to form an ignitable mixture with the oxygen in the air.

The internal combustion engine 3 is advantageously operated with a liquid energy carrier (fuel) which has a methanol and/or ethanol content of at least 50% by volume. Pure methanol (methanol content >95% by volume) is preferably used for operation in the charging column 1 illustrated in this exemplary embodiment.

This fuel can be produced from biomass in an environmentally friendly manner, has long been established worldwide as a fuel and is therefore available at low cost. Transport and storage as well as the operation of methanol in internal combustion engines 3 is comparable to conventional gasoline (for motor vehicles) and is therefore unproblematic.

The fuel is stored in the charging column 1 according to the invention in a tank 6 which is connected to the internal combustion engine 3 via the fuel line 12. To preheat the fuel, particularly when starting the internal combustion engine 3 and in its cold-running phase, a fuel heating device 13 is installed in the immediate vicinity of the fuel line 12. In this exemplary embodiment, the fuel heating device 13 is an electrical resistance heater whose current-carrying coils are wound around the fuel line 12 and thus heat the fuel in the fuel line 12.

The internal combustion engine 3 drives the generator 4 by rotation. The kinetic energy generated by the internal combustion engine 3 is thus converted into electric energy by the generator 4, into an alternating current which has a frequency of 50 Hz. The constant frequency of the alternating current is ensured by a transmission between the internal combustion engine 3 and the generator 4. The transmission is implemented, for example, by means of a gear; driving the generator 4 by means of a toothed belt or toothed chain is simpler, more cost-effective and at the same time more robust in daily operation.

Furthermore, an electric energy store 5 (rechargeable battery) 9 and a device for transporting the liquid energy carrier 11 are installed in the charging column 1. The energy store 5 supplies the control unit 9, by means of which the charging column 1 detects and initiates the beginning or the end of a charging process. In addition, the control unit 9 controls the operation of the internal combustion engine 3 in such a way that the internal combustion engine 3 runs in a defined speed range that is kept constant. This is usually in the partial load range to ensure efficient fuel consumption. To enable an increased or reduced power output, the control unit 9 can adjust the fuel metering of the internal combustion engine 3 accordingly or change the load on the generator 4. The fuel heating device 13 is also controlled by the control unit 9 in such a way that the fuel in the fuel line 12 always has a temperature of at least 15° C., but particularly during the starting process and in the cold-running phase of the internal combustion engine 3. Depending on the operating conditions of the internal combustion engine 3, an operator of the charging column 1 can adjust the temperature of the fuel to at least 30° C.; a minimum temperature of 35° C. is particularly preferred during the starting process and in the cold-running phase of the internal combustion engine 3. The current for the resistance heater of the fuel heating device 13 is provided by the electric energy store 5.

The electric energy store 5 also starts the internal combustion engine 3 via a starter and a fuel pump which delivers the fuel into the internal combustion engine 3 at the beginning of a charging process.

The electric energy store 5 is optionally recharged by the electric energy generated by the generator 4. The electric energy generated in the charging column 1 is delivered to a motor vehicle via one or more electrical connections 10 (charging cables).

A user of the charging column 1 can use the control unit 9 to pay for the charging process. Different payment systems are possible, for example using various credit cards or using a mobile device, for example a smartphone.

The internal combustion engine 3 and generator 4, tank 6, energy store 5, fuel heating device 13, control unit 9, and the electrical connections 10 are all advantageously installed in a housing 2. The charging column 1 can therefore be operated independently, i.e., it does not require an electrical connection to an existing power grid.

The electric energy required for its operation is supplied by the rechargeable energy store 5. The dimensions of the charging column 1 are also very compact, and the fuel tank 6 usually takes up the most space. By suitably selecting the size of the tank 6, the dimensions of the charging column 1 can be kept small, but it may then be necessary to fill the tank 6 with fuel frequently. For this purpose, the control unit 9 is advantageously connected to the operator of the charging column 1 via WLAN or similar communication devices and issues a respective message when the tank 6 has to be refilled.

The method according to the invention for generating a charging current for charging electric vehicles has five method steps: The charging process begins when a user plugs the electrical connection (charging cable) 10 into the respective socket of the motor vehicle to be charged. The control unit 9 detects this, and in the first method step 100 the fuel is supplied from the tank 6 to the internal combustion engine 3 by the fuel pump. In the second method step 200, the fuel is heated to at least 35° C. by means of the fuel heating device 13, particularly during the starting process and in the cold-running phase of the internal combustion engine 3. In this exemplary embodiment, the fuel heating device 13 is a resistance heater whose current-carrying coils are wound around the fuel line 12 and thus heat the fuel in the fuel line 12. The internal combustion engine 3 is started by a starter. The starter, fuel pump and fuel heating device 13 are supplied with energy by the energy store 5.

In the third method step 300, the internal combustion engine 3 is operated with the heated fuel and drives the generator 4, so the chemical energy stored in the fuel is converted into kinetic energy. In the fourth method step 400, the kinetic energy generated by the internal combustion engine 3 is converted into electric energy. In the fifth method step 500, this electric energy is delivered to the motor vehicle via the charging cable 10. The charging process ends when the user detaches the charging cable 10 from the motor vehicle or when the energy store of the motor vehicle is sufficiently charged (80% of the capacity of the energy store or more). After the charging process has ended, the internal combustion engine 3 is stopped and no more fuel is pumped to the internal combustion engine 3. The charging column 1 goes into a standby mode until the start of the next charging process.

However, the use of methanol to run a spark-ignition engine has heretofore faced a significant cold start and/or running problem not typically encountered with gasoline and diesel engines. It has been found that methanol fueled vehicle engines are difficult to start at ambient temperatures below 10° C. due to the low vapor pressure and high evaporation heat of methanol. Even if a methanol fueled engine was somehow started, the associated vehicle was found to exhibit poor drivability and/or emit high levels of carbon monoxide (CO) and uncombusted hydrocarbon emissions from the engine.

Various devices and methods have been proposed to solve these problems, including the use of fuel and carburetor heaters to aid in fuel vaporization, the use of methanol dissociation reactors to produce highly combustible gases, and the addition of volatile compounds to the methanol fuel. As for electrically heating an air/methanol fuel mixture to thereby enable cold starting at low temperatures, it has been found that the required electrical output increases dramatically.

FIG. 2 shows an embodiment of the charging column 1 according to the invention, the fuel heating device 15 of which is a PTC auxiliary heater. The charging column 1 is operated in a stationary manner and has an internal combustion engine 3. The internal combustion engine 3 is a piston combustion engine that works according to the Otto principle (4-stroke). The internal combustion engine 3 has direct injection, in which the fuel is atomized by means of a fuel injection valve 14 in the combustion chamber of the internal combustion engine 3 to form an ignitable mixture with the oxygen in the air, which is spark-ignited in the combustion chamber of the internal combustion engine 3 by means of a spark plug, for example.

The internal combustion engine 3 is advantageously operated with a liquid energy carrier (fuel) which has a methanol and/or ethanol content of at least 75% by volume. Pure ethanol (ethanol content >95% by volume) is preferably used for operation in the charging column 1 illustrated in this exemplary embodiment.

The fuel is stored in the charging column 1 according to the invention in a tank 6 which is connected to the internal combustion engine 3 via the fuel line 12. To preheat the fuel, particularly when starting the internal combustion engine 3 and in its cold-running phase, a fuel heating device 15 is installed in the immediate vicinity of the fuel line 12. In this exemplary embodiment, the fuel heating device 15 is a PTC auxiliary heater which, due to its design, is self-regulated and therefore does not require any additional temperature sensors.

The internal combustion engine 3 drives the generator 4 by rotation. The kinetic energy generated by the internal combustion engine 3 is thus converted into electric energy by the generator 4, into an alternating current which has a frequency of 50 Hz. The constant frequency of the alternating current is ensured by a transmission between the internal combustion engine 3 and the generator 4. The transmission is implemented, for example, by means of a gear; driving the generator 4 by means of a toothed belt or toothed chain is simpler, more cost-effective and at the same time more robust in daily operation.

Furthermore, an electric energy store 5 (rechargeable battery) 9 and a device for transporting the liquid energy carrier 11 are installed in the charging column 1. The energy store 5 supplies the control unit 9, by means of which the charging column 1 detects and initiates the beginning or the end of a charging process. In addition, the control unit 9 controls the operation of the internal combustion engine 3 in such a way that the internal combustion engine 3 runs in a defined speed range that is kept constant. This is usually in the partial load range to ensure efficient fuel consumption. To enable an increased or reduced power output, the control unit 9 can adjust the fuel metering of the internal combustion engine 3 accordingly or change the load on the generator 4. The fuel heating device 15 is also controlled by the control unit 9 in such a way that the fuel in the fuel line 12 always has a temperature of at least 25° C., but particularly during the starting process and in the cold-running phase of the internal combustion engine 3. Depending on the operating conditions of the internal combustion engine 3, an operator of the charging column 1 can adjust the temperature of the fuel to at least 30° C.; a minimum temperature of 35° C. is particularly preferred during the starting process and in the cold-running phase of the internal combustion engine 3. The current for the PTC auxiliary heater of the fuel heating device 15 is provided by the electric energy store 5.

The electric energy store 5 also starts the internal combustion engine 3 via a starter and a fuel pump which delivers the fuel into the internal combustion engine 3 at the beginning of a charging process. The electric energy store 5 is optionally recharged by the electric energy generated by the generator 4. The electric energy generated in the charging column 1 is delivered to a motor vehicle via one or more electrical connections 10 (charging cables).

A user of the charging column 1 can use the control unit 9 to pay for the charging process. Different payment systems are possible, for example using various credit cards or using a mobile device, for example a smartphone.

The internal combustion engine 3 and generator 4, energy store 5, fuel heating device 15, control unit 9, as well as the electrical connections 10 are all advantageously installed in a housing 2. The tank 6 is spatially separated in this embodiment. A tank 6 can thus be available to multiple charging columns 1 and supply them with fuel. Such a configuration is particularly favorable for setting up electric charging stations that include multiple charging columns 1.

The electric energy required for its operation is supplied by the rechargeable energy store 5. The dimensions of the charging column 1 are also very compact, and the fuel tank 6 usually takes up the most space. By suitably selecting the size of the tank 6, the dimensions of the charging column 1 can be kept small, but it may then be necessary to fill the tank 6 with fuel frequently. For this purpose, the control unit 9 is advantageously connected to the operator of the charging column 1 via WLAN or similar communication devices and issues a respective message when the tank 6 has to be refilled.

The method according to the invention for generating a charging current for charging electric vehicles has five method steps: The charging process begins when a user plugs the electrical connection (charging cable) 10 into the respective socket of the motor vehicle to be charged. The control unit 9 detects this, and in the first method step 100 the fuel is supplied from the tank 6 to the internal combustion engine 3 by the fuel pump. In the second method step 200, the fuel is heated to at least 25° C. by means of the fuel heating device 15, particularly during the starting process and in the cold-running phase of the internal combustion engine 3. In this exemplary embodiment, the fuel heating device 15 is a PTC auxiliary heater whose ceramic encapsulation is wound around the fuel line 12 and thus heats the fuel in the fuel line 12. The internal combustion engine 3 is started by a starter. The starter, fuel pump and fuel heating device 15 are supplied with energy by the energy store 5.

In the third method step 300, the internal combustion engine 3 is operated with the heated fuel and drives the generator 4, so the chemical energy stored in the fuel is converted into kinetic energy. In the fourth method step 400, the kinetic energy generated by the internal combustion engine 3 is converted into electric energy. In the fifth method step 500, this electric energy is delivered to the motor vehicle via the charging cable 10. The charging process ends when the user detaches the charging cable 10 from the motor vehicle or when the energy store of the motor vehicle is sufficiently charged (80% of the capacity of the energy store or more). After the charging process has ended, the internal combustion engine 3 is stopped, the fuel is no longer heated, and no more fuel is pumped to the internal combustion engine 3. The charging column 1 goes into a standby mode until the start of the next charging process.

An exemplary embodiment of the charging column 1 according to the invention without a fuel heating device 13/15 as a separate component is shown in FIG. 3. The fuel is heated by the waste heat of the internal combustion engine 3. The charging column 1 has an internal combustion engine 3. The internal combustion engine 3 is a piston combustion engine that works according to the Otto principle (4-stroke). The internal combustion engine 3 has intake manifold injection, in which the fuel is atomized by means of a fuel injection valve 14 in the combustion chamber of the internal combustion engine 3 to form an ignitable mixture with the oxygen in the air, which is spark-ignited in the combustion chamber of the internal combustion engine 3 by means of a spark plug, for example.

The internal combustion engine 3 is advantageously operated with a liquid energy carrier (fuel) which has a methanol and/or ethanol content of at least 50% by volume. A fuel mixture with an ethanol content of 85% by volume is preferably used for operation in the charging column 1 illustrated in this exemplary embodiment.

The fuel is stored in the charging column 1 according to the invention in a tank 6 which is connected to the internal combustion engine 3 via the fuel line 12. To preheat the fuel, particularly when starting the internal combustion engine 3 and in its cold-running phase, the waste heat from the internal combustion engine 3 is used in this exemplary embodiment. For this purpose, the fuel line 12 is arranged in such a way that at least in one area it runs so close to the cooling jacket of the internal combustion engine 3 that the fuel in the fuel line 12 is heated to at least 35° C. Such an arrangement of the fuel line 12 requires no additional fuel heating device 13/15.

The internal combustion engine 3 drives the generator 4 by rotation. The kinetic energy generated by the internal combustion engine 3 is thus converted into electric energy by the generator 4, into an alternating current which has a frequency of 50 Hz. The constant frequency of the alternating current is ensured by a transmission between the internal combustion engine 3 and the generator 4. The transmission is implemented, for example, by means of a gear; driving the generator 4 by means of a toothed belt or toothed chain is simpler, more cost-effective and at the same time more robust in daily operation.

Furthermore, an electric energy store 5 (rechargeable battery) 9 and a device for transporting the liquid energy carrier 11 are installed in the charging column 1. The energy store 5 supplies the control unit 9, by means of which the charging column 1 detects and initiates the beginning or the end of a charging process. In addition, the control unit 9 controls the operation of the internal combustion engine 3 in such a way that the internal combustion engine 3 runs in a defined speed range that is kept constant. This is usually in the partial load range to ensure efficient fuel consumption. To enable an increased or reduced power output, the control unit 9 can adjust the fuel metering of the internal combustion engine 3 accordingly or change the load on the generator 4.

The electric energy store 5 also starts the internal combustion engine 3 via a starter and a fuel pump which delivers the fuel into the internal combustion engine 3 at the beginning of a charging process. The electric energy store 5 is optionally recharged by the electric energy generated by the generator 4. The electric energy generated in the charging column 1 is delivered to a motor vehicle via one or more electrical connections 10 (charging cables). A user of the charging column 1 can use the control unit 9 to pay for the charging process. Different payment systems are possible, for example using various credit cards or using a mobile device, for example a smartphone.

The internal combustion engine 3 and generator 4, energy store 5, control unit 9, as well as the electrical connections 10 are all advantageously installed in a housing 2. In this exemplary embodiment, like in the previous one (FIG. 2), the tank 6 is spatially separated. A tank 6 can thus be available to multiple charging columns 1 and supply them with fuel. Such a configuration is particularly favorable for setting up electric charging stations that include multiple charging columns 1.

The electric energy required for its operation is supplied by the rechargeable energy store 5. The dimensions of the charging column 1 are also very compact, and the fuel tank 6 usually takes up the most space. By suitably selecting the size of the tank 6, the dimensions of the charging column 1 can be kept small, but it may then be necessary to fill the tank 6 with fuel frequently. For this purpose, the control unit 9 is advantageously connected to the operator of the charging column 1 via WLAN or similar communication devices and issues a respective message when the tank 6 has to be refilled.

The method according to the invention for generating a charging current for charging electric vehicles has five method steps: The charging process begins with the authentication of the user at the charging column. The control unit 9 detects this, and in the first method step 100 the fuel is supplied from the tank 6 to the internal combustion engine 3 by the fuel pump. In the second method step 200, the fuel is heated to at least 35° C. by the waste heat from the internal combustion engine 3, particularly during the starting process and in the cold-running phase of the internal combustion engine 3. The internal combustion engine 3 is started by a starter. The starter and the fuel pump are supplied with energy by the energy store 5.

In the third method step 300, the internal combustion engine 3 is operated with the heated fuel and drives the generator 4, so the chemical energy stored in the fuel is converted into kinetic energy. In the fourth method step 400, the kinetic energy generated by the internal combustion engine 3 is converted into electric energy. In the fifth method step 500, this electric energy is delivered to the motor vehicle via the charging cable 10. The charging process ends when the user detaches the charging cable 10 from the motor vehicle or when the energy store of the motor vehicle is sufficiently charged (80% of the capacity of the energy store or more). After the charging process has ended, the internal combustion engine 3 is stopped, the fuel is no longer heated, and no more fuel is pumped to the internal combustion engine 3. The charging column 1 goes into a standby mode until the start of the next charging process.

FIG. 4 shows the method according to the invention for generating a charging current for charging electric vehicles. The method according to the invention for generating a charging current for charging electric vehicles has five method steps: The charging process begins when a user wakes the charging column from stand-by mode with an input. The control unit 9 detects this, and in the first method step 100 the fuel (mixture with a methanol content >75% by volume) is supplied from the tank 6 to the internal combustion engine 3 by the fuel pump. In the second method step 200, the fuel is heated to at least 20° C. by means of the fuel heating device 13/15 or by the waste heat of the internal combustion engine 3, particularly during the starting process and in the cold-running phase of the internal combustion engine 3. The internal combustion engine 3 is started by a starter. The starter, fuel pump and fuel heating device 13/15 are supplied with energy by the energy store 5.

In the third method step 300, the internal combustion engine 3 is operated with the heated fuel and drives the generator 4, so the chemical energy stored in the fuel is converted into kinetic energy. In the fourth method step 400, the kinetic energy generated by the internal combustion engine 3 is converted into electric energy. In the fifth method step 500, this electric energy is delivered to the motor vehicle via the charging cable 10. The charging process ends when the user detaches the charging cable 10 from the motor vehicle or when the energy store of the motor vehicle is sufficiently charged (80% of the capacity of the energy store or more). After the charging process has ended, the internal combustion engine 3 is stopped, the fuel is no longer heated, and no more fuel is pumped to the internal combustion engine 3. The charging column 1 goes into a standby mode until the start of the next charging process.

In another exemplary embodiment, the intake air is heated using a PCT heating element before said air is mixed with the atomized fuel in the combustion chamber of the internal combustion engine, thereby heating the fuel. The PTC heating element comprises a PTC ceramic which abuts a metal fin element and a fan. The fan is used to conduct the air to be heated through the metal fin element. If the PTC ceramic is connected to a current, it heats itself up and transfers this heat to the metal fin element. The metal fin element acts as a heat exchanger and transfers the heat to the air flowing through the metal fin element. The fuel atomized into the combustion chamber of the internal combustion engine is then heated as the air mixes with the fuel.

In an alternative exemplary embodiment, the intake air is preheated by the waste heat from the internal combustion engine of the charging column. For this purpose, the air-guiding duct is routed over a distance of 5 cm along a heat-emitting point on the internal combustion engine before it is conducted into the combustion chamber of the internal combustion engine. There, the preheated intake air heats the fuel and forms an ignitable mixture with the fuel.

LIST OF REFERENCE NUMERALS

| | |
|---|---|
| 1 | charging column |
| 2 | housing |
| 3 | combustion engine |
| 4 | generator |
| 5 | energy store |
| 6 | tank |
| 7 | Shaft between VM and generator |
| 9 | control unit |
| 10 | electrical connection |
| 12 | fuel line |
| 13 | fuel heating device/resistance heater |
| 15 | fuel heating device/PTC heater |
| 14 | injection nozzle |
| 100 | supplying the liquid energy carrier |
| 200 | heating the liquid energy carrier |
| 300 | operating the internal combustion engine |
| 400 | converting the kinetic/electric energy |
| 500 | delivery of AC power to an electric vehicle |

1. A charging column (1), which is suitable for charging electric vehicles (90), comprising:
an internal combustion engine (3)
a tank (6) for a liquid energy carrier,
a fuel line (12) from the tank (6) to the combustion engine (3)
a fuel heating device (13) for heating the fuel in the fuel line (12)
a generator (4),
a connection device (14) which is adapted to be connected to an electric vehicle (90),
wherein the device for connecting the electric vehicle is suitable for transmitting electric energy to the electric vehicle and
wherein the generator is coupled to the internal combustion engine (3) in such a way that the kinetic energy generated by the internal combustion engine (3) can be converted into electric energy by the generator (4).

2. The charging column (1), which is suitable for charging electric vehicles (90), according to claim 1,
characterized in that
the charging column (1) has an electric energy store which is suitable and intended for providing the electric energy required for starting and/or operating the fuel heating device (13).

3. The charging column (1), which is suitable for charging electric vehicles (90), according to claim 1,
characterized in that
the internal combustion engine (3) is suitable and intended to be operated with a liquid energy carrier having a methanol and/or ethanol content of >50% by volume and/or the tank has a liquid energy carrier having a methanol and/or ethanol content of >50% by volume.

4. The charging column (1), which is suitable for charging electric vehicles (90), according claim 1,
characterized in that
the charging column (1) has a control unit (9) which is suitable and/or provided for controlling the operation of the fuel heating device (13).

5. The charging column (1), which is suitable for charging electric vehicles (90), according to claim 1,
characterized in that
the fuel heating device (13) has a PTC ceramic or an electric resistance heater.

6. The charging column (1), which is suitable for charging electric vehicles (90), according to claim 1,
characterized in that
the fuel heating device (13) is arranged in the immediate vicinity of the fuel line (12),
wherein the waste heat from the fuel heating device (13) can be used to heat the fuel line (12).

7. The charging column (1), which is suitable for charging electric vehicles, according to claim 1,
characterized in that
the charging column (1) has a housing (2) in which the internal combustion engine (3), the fuel line (12), the fuel heating device (13), the control unit, the generator (4), and/or the electric energy store are arranged.

8. The charging column (1), which is suitable for charging electric vehicles, according to claim 1,
characterized in that
the fuel heating device (13) is provided and suitable for heating the intake air in such a way that the fuel can be heated by mixing the heated air with the fuel.

9. A method for generating electric energy in a charging column (1) for charging electric vehicles (90), which method has the following method steps:
supplying fuel to an internal combustion engine (3)
heating the fuel
operating the internal combustion engine (3) with the heated fuel
generating electric energy from the kinetic energy of the internal combustion engine (3)
delivering the generated electric energy to an electric vehicle (90).

10. The method for generating electric energy in a charging column (1) for charging electric vehicles (90) according to claim 9,
characterized in that
the fuel heating device (13) is started and/or operated by electric energy from an energy store (5).

11. The method for generating electric energy in a charging column (1) for charging electric vehicles (90) according to claim 9,
characterized in that
methanol and/or ethanol having a methanol and/or ethanol content of >50% by volume is heated as fuel in the fuel line.

12. The method for generating electric energy in a charging column (1) for charging electric vehicles (90) according to claim 9,
characterized in that
the fuel is heated by the fuel heating device (13) arranged in the immediate vicinity of the fuel line (12).

13. The method for generating electric energy in a charging column (1) for charging electric vehicles (90) according to claim 9,
characterized in that
the fuel heating device (13) is operated by a control unit (9).

14. The method for generating electric energy in a charging column (1) for charging electric vehicles (90) according to claim 9,
characterized in that
the fuel is heated by a PTC ceramic and/or a resistance heater.

15. The method for generating electric energy in a charging column (1) for charging electric vehicles (90) according to claim 9,
characterized in that
the heated fuel is atomized.

16. The method for generating electric energy in a charging column (1) for charging electric vehicles (90) according to claim 9,
characterized in that
the heated fuel is mixed with a gas to form a fuel-gas mixture and then ignited in the combustion chamber of the internal combustion engine (3).

17. The method for generating electric energy in a charging column (1) for charging electric vehicles (90) according to claim 9,
characterized in that
a transmission arranged between the internal combustion engine (3) and the generator (4) is designed in such a way that the current generated by the generator (4) alternates at a frequency of 50 Hz.

18. The method for generating electric energy in a charging column (1) for charging electric vehicles (90) according to claim 9,
characterized in that
the fuel is heated by the fuel heating device (13) to a temperature T of T > 10° C., preferably T > 15° C., and particularly preferably T > 20° C.

19. The method for generating electric energy in a charging column (1) for charging electric vehicles (90) according to claim 9,
characterized in that
the fuel is heated as a result of mixing with preheated air.
